(19) United States
(12) Patent Application Publication
(10) Pub. No.: US 2005/0091449 A1
(43) Pub. Date: Apr. 28, 2005

(54) System, method and software for faster parity based raid creation

(75) Inventor: Jacob Cherian, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/692,397

(22) Filed: Oct. 23, 2003

(51) Int. Cl. G06F 12/00

(52) U.S. Cl. 711/114

(57) ABSTRACT

A method, system and software for reduced resource parity based RAID creation are disclosed. In a preferred embodiment, a filter driver is incorporated between a volume manager driver and a disk driver of an operating system running on an information handling system. In operation, the filter driver preferably intercepts all read and write operations to the data portion of the parity based RAID volume, and instead of processing the read and write operations to the data in accordance with normal procedures, substitutes responses expected by the read or write requesting application. In operation, parity based RAID build times are dramatically reduced through the elimination of non-critical data portion accesses and by prioritizing RAID configuration operations.

### TECHNICAL FIELD

The present invention relates generally to information handling systems and, more particularly, to creating storage management solutions on information storage devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Network attached storage (NAS) systems is a member of the information handling system family. Low-end NAS systems typically support integrated Advanced Technology Attachment (ATA) disk drives and commonly use software redundant arrays of inexpensive disks (RAID) based on an information handling system operating system volume manager to provide RAID-5 redundancy for its data volumes.

The process of creating a RAID-5 volume consists generally of two processes. First, the volume manager structures or configuration information on the disk drives is updated. Next, the RAID-5 is typically initialized so that it is consistent, i.e., parity is calculated for the stripes and written.

The creation of a RAID-5 data volume is typically expensive in terms of time. The time required for building a RAID-5 generally means that it takes the factory a significant amount of time to build a low-end network attached storage system. The time it takes to build a software RAID-5 is enormous in comparison to the time it takes to build a RAID-5 system based on hardware RAID or, to build no RAID at all. As a result of the increase in time spent in the factory build process, the cost of manufacturing a low end network attached storage system is significantly increased.

In some factories, build times are on the order of three to four hours with one-hundred-twenty (120) gigabyte hard drive devices with drive sizes due to increase, these build times will get progressively worse. The next drive size expected for implementation in low end network attached storage systems is likely to be on the order of two-hundred-fifty(250) gigabytes. Such a drive size will approximately double the time it takes to build a RAID-5 low end network attached storage (NAS) system.

Experimentation shows that most of the time spent in building a RAID-5 data volume is spent in the initialization process. In particular, the read and write operations and calculation of parity for the initialization of the RAID-5 build process consume the vast majority of time.

### SUMMARY

In accordance with teachings of the present disclosure, a system, method and software for enabling faster parity based RAID creation, such as RAID-3 and RAID-5 are provided.

In one aspect, teachings of the present disclosure provide a method for volume manager based redundant array of inexpensive disk creation. The method preferably includes obtaining information on a data portion of a disk RAID volume, verifying that disks of the RAID volume are zeroed and aborting RAID creation if the disks are not zeroed. Further, the method preferably also provides monitoring input/output (I/O) operations between an information handling system volume manager and an information handling system disk driver, as well as intercepting all I/O operations between the volume manager and the disk driver. If an intercepted I/O operation is a write operation directed to the data portion of the RAID volume, the method preferably provides for returning a success status to a requesting application. If an intercepted I/O operation is a read operation of the data portion of the RAID volume, the method preferably provides for returning a zeroed buffer to a requesting application. In addition, if an intercepted I/O operation is a non-data portion access I/O operation, the method preferably provides for passing the non-data portion access I/O operation to the disk driver for processing.

In another aspect, teachings of the present invention provide an information handling system including at least one processor, a memory and at least three information storage devices operably coupled to the processor. In addition, a program of instructions storable in the memory and executable by the processor is included and is preferably operable to intercept input/output (I/O) operations during creation of a RAID on the information storage devices. In addition, the program of instructions is preferably further operable to process I/O operations directed to accessing RAID disk structures, process I/O operations directed to accessing RAID configuration information as well as provide for the processing of I/O operations directed to accessing a data portion of the RAID.

In a further aspect, teachings of the present disclosure provide a computer readable medium including a program of instructions, the program of instructions implementing a method for RAID creation. The program of instructions is preferably operable to cause an information handling system to monitor I/O operations submitted for processing by an information handling system disk driver and to filter I/O operations associated with a data portion of the RAID.

A technical advantage provided by teachings of the present disclosure includes enabling lower cost network attached storage systems to be developed through faster volume manager based RAID creation.

In another aspect, teachings of the present disclosure provide the technical advantage of enabling all systems employing volume manager RAID to reduce RAID creation times.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram depicting an exemplary embodiment of an information handling system according to teachings of the present disclosure;

FIG. 2 illustrates a block diagram depicting an exemplary embodiment of a driver stack according to teachings of the present disclosure;

FIG. 3 is a flow diagram depicting an exemplary embodiment of filter driver initialization according teachings of the present disclosure;

FIG. 4 is a flow diagram depicting an exemplary embodiment of filter driver operation according to teachings of the present disclosure; and

FIG. 5 is a flow diagram depicting an exemplary embodiment of filter driver use in a factory RAID build process according to teachings of the present disclosure.

### DETAILED DESCRIPTION

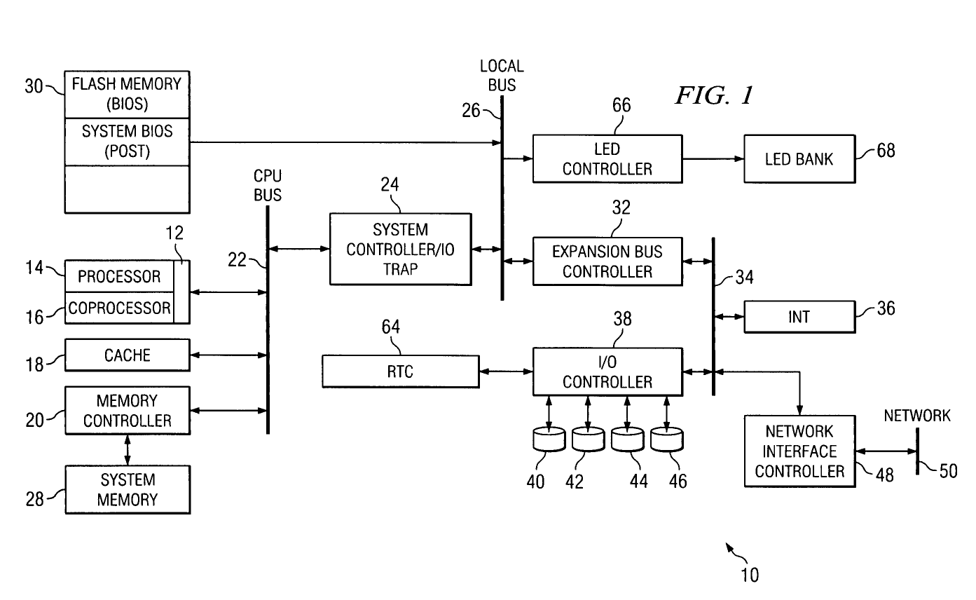

Preferred embodiments and their advantages are best understood by reference to FIGS. 1 through 5, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of an information handling system, such as a network attached storage (NAS) appliance, is shown, according to teachings of the present disclosure. Information handling system 10 preferably includes at least one microprocessor or central processing unit (CPU) 12. CPU 12 may include processor 14 for handling integer operations and coprocessor 16 for handling floating point operations. CPU 12 is preferably coupled to cache 18 and memory controller 20 via CPU bus 22. System controller I/O trap 24 preferably couples CPU bus 22 to local bus 26 and may be generally characterized as part of a system controller. Main memory 28 of dynamic random access memory (DRAM) modules is preferably coupled to CPU bus 22 by a memory controller 20.

Basic input/output system (BIOS) memory 30 is also preferably coupled to local bus 26. FLASH memory or other nonvolatile memory may be used as BIOS memory 30. A BIOS program (not expressly shown) is typically stored in BIOS memory 30. The BIOS program preferably includes software which facilitates initialization of information handling system 10 devices such as a keyboard (not expressly shown), a mouse (not expressly shown), or other devices as well as aids in the initial loading of the operating system.

Bus interface controller or expansion bus controller 32 preferably couples local bus 26 to expansion bus 34. Expansion bus 34 may be configured as an Industry Standard Architecture (“ISA”) bus or a Peripheral Component Interconnect (“PCI”) bus. Other NAS deployments may include alternative expansion bus technologies.

Interrupt request generator 36 is also preferably coupled to expansion bus 34. Interrupt request generator 36 is preferably operable to issue an interrupt service request over a predetermined interrupt request line in response to receipt of a request to issue interrupt instruction from CPU 12.

I/O controller 38 is also preferably coupled to expansion bus 34. I/O controller 38 preferably interfaces to Advanced Technology Attachment (ATA) hard drives 40, 42, 44 and 46. While reference herein is made to ATA hard drive devices, it should understood that teachings of the present disclosure may also be implemented with other hard drive device or storage technologies including, but not limited to, Serial Advanced Technology Attachment (SATA) devices, Small Computer Systems Interface (SCSI) devices, and Fiber Channel devices.

Network interface controller 48 is preferably provided and enables information handling system 10 to communicate with communication network 50, e.g., an Ethernet network. Communication network 50 may include a local area network (“LAN”), wide area network (“WAN”), Internet, Intranet, wireless broadband or the like. Network interface controller 48 preferably forms a network interface for communicating with other information handling systems (not expressly shown) coupled to communication network 50. An information handling system's communication components generally include hardware as well as software components. Examples of hardware components include network interface controller 48 and communication network 50. Examples of software components specific to NAS may include file server services and network administration services.

Real-time clock (RTC) 64 may also be coupled to I/O controller 38. Real-time clock 64 may be programmed to generate an alarm signal at a predetermined time as well as to perform other operations.

In general, teachings of the present disclosure describe a mechanism by which RAID volume configuration information can be written to storage disks without requiring the initialization of all the blocks in each RAID volume. In one embodiment, teachings of the present disclosure provide for using a filter between an information handling system 10 operating system disk driver and volume manager driver. Once enabled, the filter driver will preferably intercept all I/O transactions between the volume manager and the disk driver. In operation, the filter driver will preferably allow only those I/O transactions that access the disk structures and configuration information of a RAID volume to go through. All other I/O transactions would generally be handled by the filter driver. Any write operations directed to the data portion of the RAID intercepted by the filter driver, will preferably be returned to the write requesting application with a “good” or “success” status. Any intercepted read operations will preferably be returned with a zero buffer, which is typically the correct parity for zeroed out disk drives, to the read requesting application. One advantage of teachings of the present disclosure is that a RAID creation implementation in accordance with teachings of the present disclosure generally handles the case where the volume manager either writes data to all the disk drives or uses read-modify-write to initialize a RAID-5 configuration.

In general, a RAID-5 data storage configuration involves a number of independent data disks with distributed parity blocks. In a typical RAID-5 implementation, each data block is written on a data disk. The parity for blocks in the same ranks is generally generated on writes, recorded in a distributed location and checked on reads. At a minimum, RAID level 5 requires a minimum of three drives to implement.

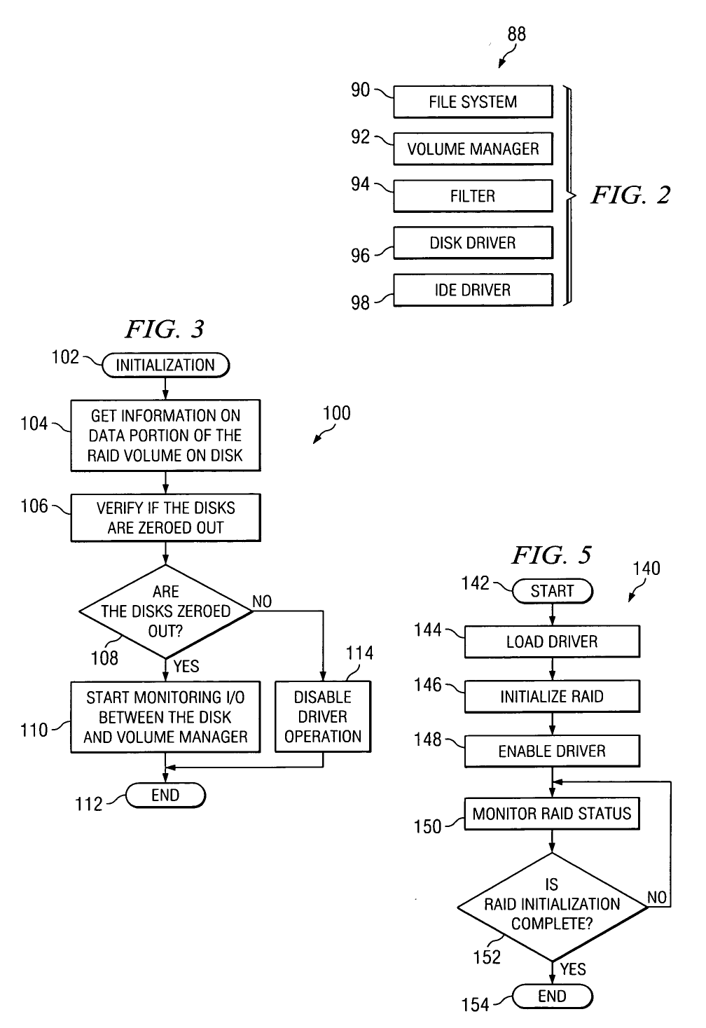

Referring now to FIG. 2, a block diagram depicting a driver stack incorporating teachings of the present disclosure is shown generally at 88. As mentioned above, one implementation of teachings of the present disclosure enables a program of instructions, storable on a computer-readable medium, to be implemented on information handling system 10 and to perform the various preferred operations discussed herein. In one embodiment, a filter driver incorporating teachings of the present disclosure may be implemented alongside one or more drivers included in an operating system running on information handling system 10. As depicted generally at 88, an information handling system 10 having an operating system running thereon and incorporating a filter driver as taught by the present disclosure, may include a file system driver 90, a volume manager driver 92, a filter driver 94 according to teachings of the present disclosure, a disk driver 96 and an Advanced Technology Attachment (ATA) driver 98. Alternative driver stack arrangements are contemplated within the spirit, scope, and teachings of the present disclosure.

In a conventional operating system, read, write and other operations are typically passed from one or more applications running on information handling system 10 to file system driver 90. Using intelligence and operations incorporated in file system driver 90, the operations received there may be reviewed and sorted as necessary. Selected ones of the operations received by file system driver 90 may be passed to volume manager driver 92. In a conventional operating system, the intelligence and operations incorporated in volume manager driver 92 may be applied to operations received thereby and subsequently passed to disk driver 96. Applying the intelligence and operations incorporated in disk driver 96, operations received thereby may then be passed to ATA driver 98 for processing in accordance with its intelligence and operations.

As shown in FIG. 2, generally at 88, one implementation of teachings of the present disclosure involves enabling a filter driver incorporating teachings of the present disclosure between volume manager driver 92 and disk driver 96. While discussion herein may refer primarily to incorporation of filter driver 94 between volume manager driver 92 and disk driver 96 of driver stack 88, other implementations are considered within the spirit and scope of the present disclosure.

Referring now to FIG. 3, a flow diagram depicting one embodiment of the initialization of filter driver 94 is shown generally at 100. Upon initialization of method 100 at 102, method 100 preferably proceeds to 104 where information regarding a data portion of the RAID volume on disk may be obtained, e.g., obtaining the beginning and ending addresses of the RAID volume's data portion, the size of the data portion, etc. In general, the actual process of determining the extents of the data portion of a RAID on a disk, as opposed from RAID configuration information, depends on the implementation of the operating system's volume manager driver 92. In one aspect, this information may be read from the disks. In an alternate aspect, this information may be obtained by using one or more operating system and/or volume manager application program interfaces (API). Once desired information regarding the data portion of the RAID volume on disk has been obtained at 104, method 100 preferably proceeds to 106.

At 106 of method 100, HDD 40, 42, 44 and 46 of information handling system 10 are preferably read to determine their state. In particular, at 106 of method 100, HDD 40, 42, 44 and 46 are preferably reviewed to determine whether the information storage devices have been zeroed out. A number of methodologies may be used to determine if HDD 40, 42, 44 and 46 are zeroed out. For example, one method to determine whether HDD 40, 42, 44 and 46 are zeroed out is to do sample reads within the full range of the disk logical block addresses (LBA) and to verify that the data read back is all zeroes. In such a methodology, the greater the number of samples, the greater the probability that the disks are in fact fully zeroed out.

At 108, an evaluation or review of the data acquired at 106 is preferably made. If at 108 it is determined that the disk drives of information handling system 10 are in fact zeroed out, method 100 preferably proceeds to 110 where filter driver 94 of the present disclosure may begin monitoring I/O operations between a volume manager driver and a disk driver of an information handling system operating system, such as volume manager driver 92 and disk driver 96. Once monitoring has been initiated at 110, method 100 may proceed to 112.

Alternatively, if at 108 it is determined that the information obtained at 106 shows that the disk drives of information handling system 10 are not in a zeroed out state, method 100 preferably proceeds to 114 where the filter driver of the present disclosure is preferably disabled. If the filter driver 94 is disabled at 114, method 100 preferably ends at 112. As such, in one embodiment, the disk drives of an information handling system in which a filter driver incorporating teachings of the present disclosure is to operate may be required to be in a zeroed out state. An alternate implementation of teachings of the present disclosure may incorporate one or more of a plurality of methods for zeroing out the disk drives of a selected information handling system.

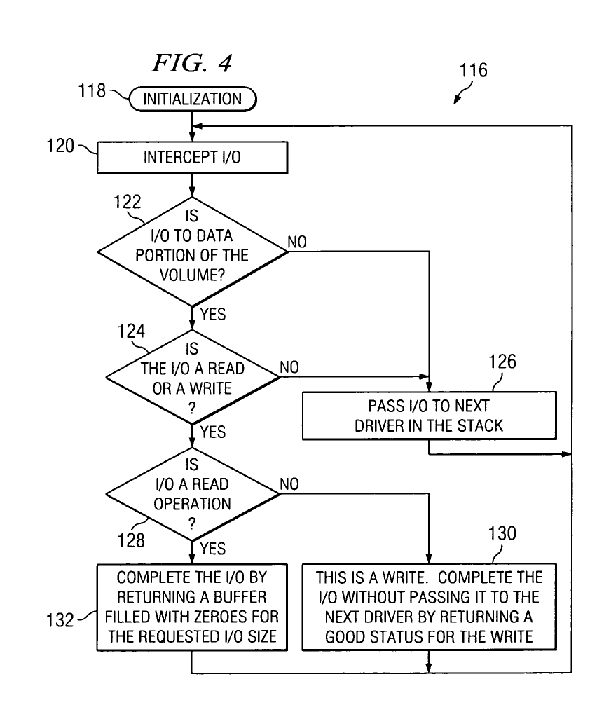

Referring now to FIG. 4, a flow diagram depicting one embodiment of filter driver 94 operation is shown generally at 116. Upon initialization at 118, such as through fulfilling step 110 of method 100 illustrated in FIG. 3, method 116 preferably proceeds to 120. At 120, preferably all I/O operations between volume manager 92 and disk driver 96 of driver stack 88 are intercepted by filter driver 94. Upon interception of an I/O operation at 120, method 116 preferably proceeds to 122.

At 122, each I/O operation is preferably evaluated to determine whether the I/O operation concerns the data portion of a selected RAID volume or configuration information regarding the RAID volume(s) being established on one or more of disk drive devices 40, 42, 44 and 46 of information handling system 10. As such, at 122, each intercepted I/O operation is preferably evaluated to determine whether the I/O operation concerns the data portion of the selected RAID volume. If at 122 the I/O operation being evaluated is determined to concern the data portion of the selected RAID volume, method 116 preferably proceeds to 124. Alternatively, if at 122 the I/O operation being evaluated is determined not to concern the data portion of a RAID volume, e.g., the I/O operation concerns RAID configuration information, method 116 preferably proceeds to 126 where the I/O operation is preferably passed to the next driver in the driver stack for processing associated therewith, for example, disk driver 96.

At 124, the I/O operation concerning the data portion of the RAID volume identified at 122 is preferably evaluated to determine whether the I/O operation is a read operation or a write operation. If at 124, it is determined that the I/O operation concerning the data portion of the RAID volume is neither a read operation nor a write operation, method 116 preferably proceeds to 126 where the I/O operation may be passed to the next driver in the driver stack for processing associated therewith, for example, disk driver 96. If, however, it is determined at 124 that the I/O operation is either a read or write operation, method 116 preferably proceeds to 128.

At 128, the I/O operation is preferably distinguished to be either a read operation or a write operation. At 128 of FIG. 4, method 116 may determine whether or not the I/O operation is a read operation. If at 128 it is determined that the I/O operation is not a read operation, i.e., it is a write operation, method 116 preferably proceeds to 130. At 130, the I/O operation is acknowledged as a write operation and, according to teachings of the present disclosure, instead of processing the I/O operation in accordance with normal write operation processing and procedures, a good or success status is preferably returned to the write requesting application in lieu of actually processing the I/O operation. In one embodiment, instead of completing the I/O operation by passing it to the next driver, “good”, “successful” or a similar status is preferably returned by filter driver 94 to the write requesting application.

Alternatively, if at 128 the I/O operation is determined to be a read operation, method 116 preferably proceeds to 132. Instead of actually processing the read I/O operation in accordance with normal I/O processing procedures, filter driver 94, in one embodiment, will preferably return a buffer filled zeroes for the requested read I/O operation size to the read requesting application. In the factory build process, the correct parity for disk drives in a RAID-5 build is zero. As such, in implementing filter driver 94 in a RAID-5 build process, method 116 at 132 in conjunction with the disk drive zeroed out verification of method 100 may eliminate time allotted to a read operation during the RAID build process by returning a buffer filled with zeroes for the requested I/O operation size. Upon completion of 126, 130 and 132, method 116 preferably returns to 120 where the next I/O operation may be intercepted and evaluated generally in accordance with method 116 as described above.

Referring now to FIG. 5, a flow diagram depicting a RAID-5 factory build process according to teachings of the present disclosure is shown generally at 140. Upon initialization at 142, method 140 preferably proceeds to 144. At 144, a filter driver incorporating teachings of the present disclosure is preferably loaded onto an information handling system 10 desired to be configured with a RAID-level-5. Upon a filter driver loading at 144, method 140 preferably proceeds to 146.

At 146, the RAID-5 build process is preferably initialized. Upon initialization of the RAID-5 build process at 146, method 140 preferably proceeds to 148.

At 148, the filter driver loaded at 144 is preferably enabled at 148. In one embodiment, methods 100 and 116, of FIGS. 3 and 4, respectively, may be implemented generally in conjunction with step 148 of method 140. Alternate implementations of methods 100 and 116 may also be effective. Such alternative implementations are considered within the spirit and scope of the present disclosure. Once the filter driver of the present disclosure has been initialized and enabled, such as at 148, method 140 preferably proceeds to 150 and 152 for implementation of a RAID completion monitoring loop.

As operations in the RAID build completion monitoring loop, the status of the RAID build is preferably monitored at 150. At 152, a determination is preferably made as to whether the RAID initialization has been completed. If at 152 it is determined that the RAID build/initialization process has not completed, method 140 preferably returns to 150 where continued monitoring of RAID initialization status may be checked. Alternatively, if at 152 it is determined that the RAID build/initialization process has been completed, method 140 preferably proceeds to 154 where it may end. In an alternate embodiment, prior to method 140 ending at 154, the filter driver of the present disclosure may be removed from information handling system 10. For example, the filter driver loaded 144 of method 140 may be deleted prior to method 140 ending at 154. Alternative and/or substitute operations may be incorporated into methods 100, 116 and 140 without departing from the spirit and scope of teachings of the present disclosure.

Although the disclosed embodiments have been described in detail, it should be understood that various changes, substitutions and alterations can be made to the embodiments without departing from their spirit and scope.

1. A method for volume manager based redundant array of independent disks (RAID) creation, comprising:
obtaining information on a data portion of a disk RAID volume;
verifying that disks of the RAID are zeroed;
aborting RAID creation if the disks are not zeroed;
monitoring input/output (I/O) operations between an information handling system volume manager and an information handling system disk driver;
intercepting all I/O operations between the volume manager and the disk driver;
if an intercepted I/O operation is a write operation to the data portion of the RAID volume, returning a success status to a requesting application;
if an intercepted I/O operation is a read operation of the data portion of the RAID volume, returning a zeroed buffer to a requesting application; and
if an intercepted I/O operation is a non-data portion access I/O operation, passing the non-data portion access I/O operation to the disk driver for processing.

2. The method of claim 1, further comprising initializing creation of a parity based RAID.

3. The method of claim 2, further comprising creating a RAID-5 parity based RAID.

4. An information handling system, comprising at least one processor;
a memory operably associated with the processor;
at least three information storage devices operably coupled to the memory and the processor; and
a program of instructions storable in the memory and executable by the processor, the program of instructions operable to intercept input/output (I/O) operations during creation of a redundant array of independent disks (RAID) on the information storage devices, process I/O operations directed to accessing RAID disk structures, process I/O operations directed to accessing RAID configuration information and provide for processing of I/O operations directed to accessing a data portion of the RAID.

5. The information handling system of claim 4, further comprising the program of instructions operable to intercept I/O instructions between a volume manager and a disk driver of the information handling system.

6. The information handling system of claim 5, further comprising the program of instructions operable to intercept all I/O operations between the volume manager and the disk driver during RAID creation.

7. The information handling system of claim 4, further comprising the program of instructions operable to verify that the information storage devices have been zeroed.

8. The information handling system of claim 4, further comprising the program of instructions operable to respond to read operations of the data portion with a zeroed buffer.

9. The information handling system of claim 4, further comprising the program of instructions operable to respond to write operations to the data portion with a successful status.

10. The information handling system of claim 4, further comprising the program of instructions operable during creation of a parity-based RAID.

11. The information handling system of claim 10, further comprising the program of instructions operable during creation of a RAID-5 parity-based RAID.

12. A computer readable medium comprising a program of instructions, the program of instructions implementing a method for redundant array of independent disks (RAID) creation, the program of instructions operable to cause an information handling system to:
monitor input/output (I/O) operations submitted for processing by an information handling system disk driver; and
filter I/O operations associated with a data portion of the RAID.

13. The computer readable medium of claim 12, further comprising the program of instructions operable to return write operations to the data portion of the RAID with a predefined status.

14. The computer readable medium of claim 13, further comprising the program of instructions operable to return write operations with a good status.

15. The computer readable medium of claim 12, further comprising the program of instructions operable to return read operations of the data portion with a predefined parity value.

16. The computer readable medium of claim 15, further comprising the program of instructions operable to return zero parity value.

17. The computer readable medium of claim 12, further comprising the program of instructions operable to intercept all I/O operations between a volume manager and a disk driver of the information handling system.

18. The computer readable medium of claim 12, further comprising the program of instructions operable to pass to the disk driver for processing, I/O operations associated with configuration of the RAID.

19. The computer readable medium of claim 12, further comprising the program of instructions operable to pass to the disk driver for processing, I/O operations concerning RAID disk structures.

20. The computer readable medium of claim 12, further comprising the program of instructions operable during RAID-5 creation.
